(19) United States
(12) Patent Application Publication
(10) Pub. No.: US 2008/0052445 A1
(43) Pub. Date: Feb. 28, 2008

(54) FLASH MEMORY DEVICES INCLUDING BLOCK INFORMATION BLOCKS AND METHODS OF OPERATING SAME

(76) Inventors: Eun-Kyoung Kim, Seoul (KR); Hyun-Sun Mo, Seoul (KR); Sang-Chul Kang, Gyeonggi-do (KR)

Correspondence Address: MYERS BIGEL SIBLEY & SAJOVEC, PO BOX 37428, RALEIGH, NC, 27627, US

(21) Appl. No.: 11/669,553

(22) Filed: Jan. 31, 2007

(30) Foreign Application Priority Data
Aug. 24, 2006 (KR) 2006-80693

(51) Int. Cl. G06F 12/00

(52) U.S. Cl. 711/103

(57) ABSTRACT

Disclosed is a semiconductor memory device including pluralities of memory blocks each of which is segmented into main and spare regions, and a block information storing region storing block information of the memory blocks.

### CROSS-REFERENCE TO RELATED APPLICATION

This U.S. non-provisional patent application claims priority under 35 U.S.C. §119 of Korean Patent Application No. 2006-80693 filed on Aug. 24, 2006, the entire contents of which are hereby incorporated by reference.

### FIELD OF THE INVENTION

The present invention disclosed herein relates to semiconductor memory devices and more particularly, to flash memory devices.

### BACKGROUND

Flash memory devices as nonvolatile memories are kinds of electrically erasable and programmable read-only memories (EEPROMs) in which plural memory blocks can be written with data by one operation of programming. A general EEPROM is operable in the feature that one memory block is erasable or programmable at a time. This means that the flash memories may operate more rapidly and be more effective in systems which read and write data from and into other memory areas at the same time. Flash memories or EEPROMs are commonly usually configured such that insulation films enclosing charge storage elements used for storing data wear out over time due to repeated operations.

Flash memories store information on their silicon chips even without power supply. Namely, flash memories are able to retain information thereof without power consumption even in the condition of interruption of the power supply to the chips. In addition, flash memories offer resistance to physical shocks and fast access times for reading. With those features, the flash memories are widely used as storage units in electronic apparatuses powered by batteries. The flash memories are generally classified in two types of NOR and NAND in accordance with logical arrangement of gates.

As shown in FIG. 1, the flash memory usually includes a memory cell array for storing data information. The memory cell array has a plurality of memory blocks BLK0˜BLKn-1. Each memory block can be used for storing data. Each memory block is segmented into main and spare regions. The spare region may be used for storing a variety of information. For instance, the spare region can be used for storing information about the main region, i.e., information about the memory block (hereinafter, referred to as ‘block information’). Such block information represents whether its corresponding block is a bad block or not. For example, if a memory block is detected as being a bad block, as illustrated in FIG. 1, its associated spare region of the memory block can be updated to reflect that the associated memory block is bad.

There are problems in a flash memory storing block information in the manner shown in FIG. 1, as follows. First, when reading block information for memory blocks, each of the selected memory blocks may need to be read out to access the block information from the associated spare region of the selected memory block. This operation may consume a long time to read the block information. Further, the spare region for each block is allocated to store the block information, which degrades efficiency in utilizing the spare region.

### SUMMARY OF THE INVENTION

In some embodiments according to the present invention, a non-volatile semiconductor memory device includes a plurality of memory blocks which are segmented into main and spare regions, respectively, and a block information storing region that is configured to store block information of the memory blocks.

In some embodiments according to the present invention, a memory cell array includes a plurality of memory blocks each of which is segmented into main and spare regions, and a block information region that is configured to store block information associated with the memory blocks, a page buffer circuit that is configured to read the block information from the block information storing region. A register block is configured to store the block information transferred from the page buffer circuit through a column selection circuit.

In some embodiments according to the invention, a method of operating a non-volatile memory device includes storing block information associated with a plurality of memory blocks of the non-volatile memory device in a separately addressable block information storing region.

A further understanding of the nature and advantages of the present invention herein may be realized by reference to the remaining portions of the specification and the attached drawings.

### BRIEF DESCRIPTION OF THE FIGURES

Non-limiting and non-exhaustive embodiments of the present invention will be described with reference to the following figures, wherein like reference numerals refer to like parts throughout the various figures unless otherwise specified. In the figures:

FIG. 1 is a schematic showing a scheme of managing bad block information in a flash memory device according to a conventional art;

FIG. 2 is a block diagram illustrating a flash memory device in some embodiments according to the present invention;

FIG. 3 is a flow chart showing an operation for outputting bad block information to external from the flash memory device shown in FIG. 2 in some embodiments according to the present invention;

FIG. 4 is a flow chart showing for storing bad block information of all memory blocks in the flash memory device shown in FIG. 2 in some embodiments according to the present invention; and

FIG. 5 is a flow chart showing an operation for storing bad block information when there are program fails in the flash memory device shown in FIG. 2 in some embodiments according to the present invention.

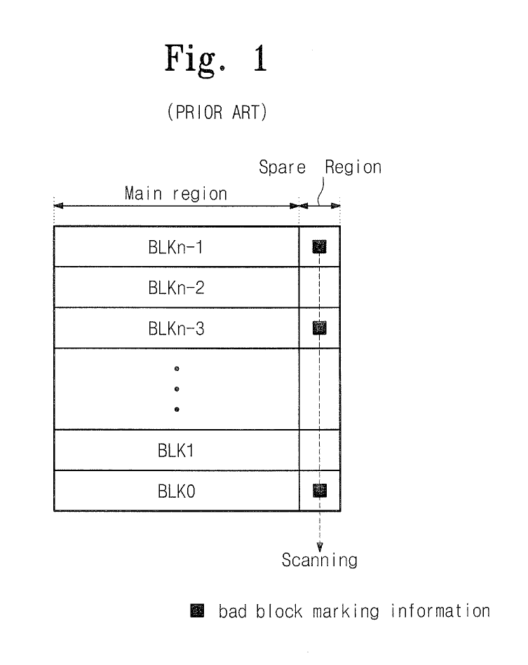

### DESCRIPTION OF EMBODIMENTS ACCORDING TO THE INVENTION

Preferred embodiments of the present invention will be described below in more detail with reference to the accompanying drawings, showing a flash memory device as an example for illustrating structural and operational features by the invention.

The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Like reference numerals refer to like elements throughout the accompanying figures.

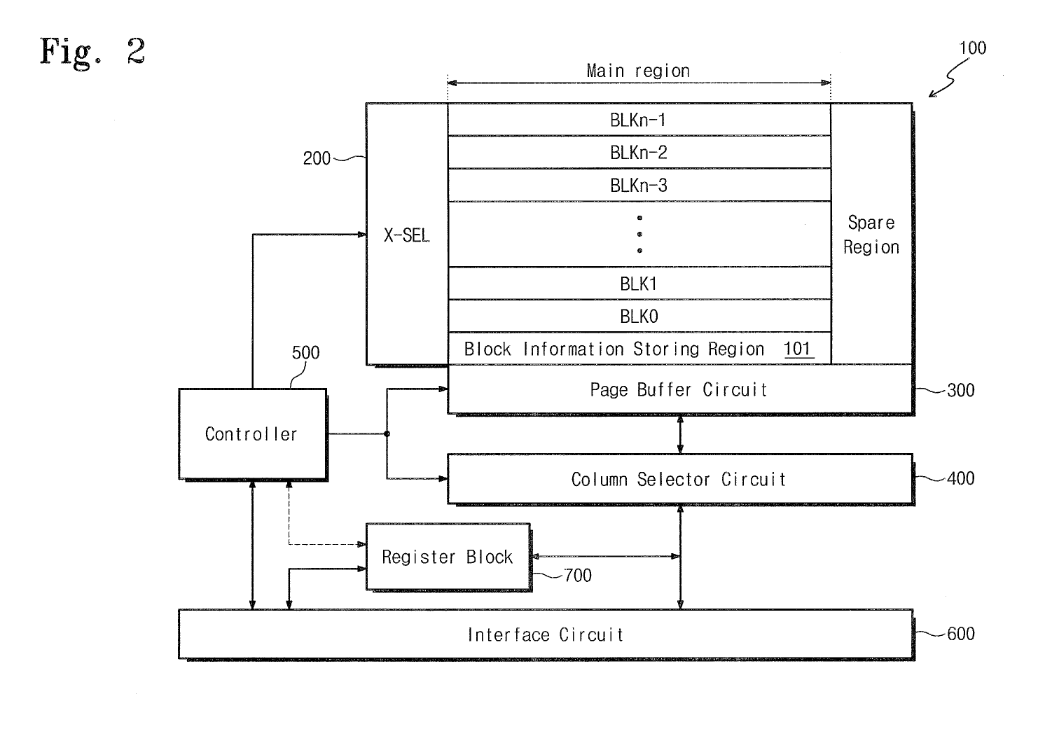

FIG. 2 is a block diagram illustrating a flash memory device in accordance with the present invention. The flash memory device according to the present invention is a NAND flash memory device. But, the present invention is applicable to other non-volatile memory devices (e.g., magnetic RAM, phase-changeable RAM, ferroelectric RAM, NOR flash memory, and so on).

Referring to FIG. 2, the flash memory device of embodiments of the present invention includes a memory cell array 100. The memory cell array 100 is organized to include pluralities of memory blocks BLK0˜BLKn-1. Each memory block is composed of main and spare regions. In some embodiments according to the present invention, the flash memory device includes a block information storing region 101 that is configured to store block information reflecting the status of the memory blocks BLK0˜BLKn-1. The block information may contain information representing whether each memory block is a bad block. It will be understood that, in some embodiments according to the present invention, the block information may include other types of information as well or may be used to store information that does not relate to bad blocks. The block information storing region 101 may be composed of one or more memory blocks.

A row selection circuit 200 is regulated by a control block (sometimes referred to as a controller) 500, selecting memory blocks in response to addresses provided from an interface circuit 600. And, the row selection circuit 200 selects one of word lines arranged in a selected memory block. Although not shown, the row selection circuit 200 drives a selected word line with a word line voltage provided from a word line voltage generator. A page buffer circuit 300 is also regulated by the control block 500, reading data from the memory cell array 100 during a read operation. The page buffer circuit 300 may be configured to store data transferred through the interface circuit 600 and a column selection circuit 400, during a program operation, and to program data, which are held therein, into the memory cell array. Although not explicitly shown, the page buffer circuit 300 may include a plurality of page buffers each corresponding to pairs of bit lines arranged in the memory cell array 100. The column selection circuit 400 is regulated by the control block 500, selecting the page buffers in response to column addresses provided through the interface circuit 600. The control block 500 may be configured to regulate overall operations (e.g., reading, programming, and erasing operations) of the flash memory device according to the present invention.

In some embodiments according to the present invention, the row selection circuit 200 is configured to select a memory block preliminarily established at a time of power-up and to select at least a word line of a selected memory block. Also, the column selection circuit 400 can be configured to select the page buffers of the page buffer circuit 300 in a predetermined unit. The row and column selection circuits, 200 and 400, are initialized with addresses preliminarily established at the power-up time.

In some embodiments according to the present invention, the flash memory device further includes a register block 700. The register block 700 functions to store block information read out from the block information storing region 101 at the power-up time. The register block 700 outputs the block information, which is stored therein, in response to addresses externally provided through the interface circuit 600. Namely, the block information stored in the register block is output through the interface circuit 600 under regulation of the control block 500 when a specific command is applied to the control block 500. As will be understood by those skilled in the art, the block information stored in the register block 700 may be externally provided in various ways and is not limited to those described herein.

As can be seen from the aforementioned description, it is possible to shorten a time for reading the block information by storing the block information of each memory block in the block information storing region 101 not in the spare regions. In addition, it is possible to improve the efficiency of using the spare regions by storing the block information of each memory block in the block information storing region 101 not in the spare regions.

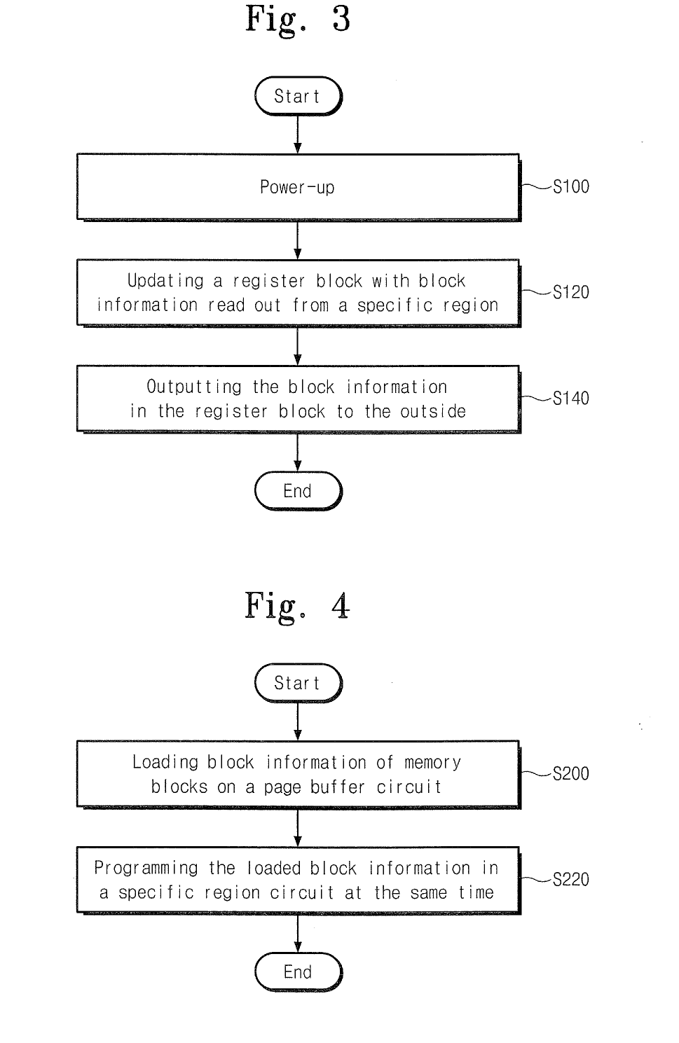

FIG. 3 is a flow chart showing an operation for outputting bad block information to external from the flash memory device shown in FIG. 2 in some embodiments according to the present invention.

Referring to FIG. 3, when a power source voltage is supplied to the flash memory device (S100), i.e., at the power-up time, the block information storing region 101 is designated by the row selection circuit 200 and then the page buffer circuit 300 reads the block information from the block information storing region 101 and can avoid reading the spare region of each memory block. The block information read out thereby is transferred to the register block 700 through the column selection circuit 400. Namely, the register block 700 is updated with the block information read out from the block information storing region 101 (S120). The block information stored in the register block 700 is output from the array through the interface circuit 600 (S140). As described in conjunction with FIG. 2, the block information stored in the register block 700 may be output to external by means of various schemes.

As can be seen from the aforementioned description, it is possible to shorten a time for reading the block information by reading the block information from the block information storing region 101 and avoid reading the spare regions of each memory block. This means that it is possible to reduce time for a boot operation at the power-up time.

FIG. 4 is a flow chart showing for storing bad block information of memory blocks in the flash memory device shown in FIG. 2 in some embodiments according to the present invention.

Referring to FIG. 4, block information of the memory blocks BLK0˜BLKn-1 is loaded in the page buffer circuit 300 through the interface circuit 600 and the column selection circuit 400 under regulation of the control block 150 (S200). Once the block information of the memory blocks BLK0˜BLKn-1 is loaded in the page buffer circuit 300, the loaded block information is programmed at a time into the block information storing region 101 in accordance with regulation by the control block 150 (S220).

Comparing this scheme with the case of storing block information in the spare regions of the memory blocks, it is possible to shorten a time for programming the block information by storing the block information of the memory blocks BLK0˜BLKn-1 in the block information storing region 101 at a time. This means that it is possible to reduce a cost for product. For instance, block information obtained from testing the flash memory device should be noted in the spare region of each memory block. If the block information is stored in the spare regions of the memory blocks, (as done in some prior art devices and methods) it may require programming to all the memory blocks. In contrast, if the block information of the memory blocks BLK0˜BLKn-1 is stored in the block information storing region 101, (as done in some embodiments according to the present invention) the programming of the block information may be performed to the storing region 101. Therefore, in some embodiments according to the present invention, the time for shipping a product of flash memory device may be reduced, hence allowing for reduced cost for manufacturing.

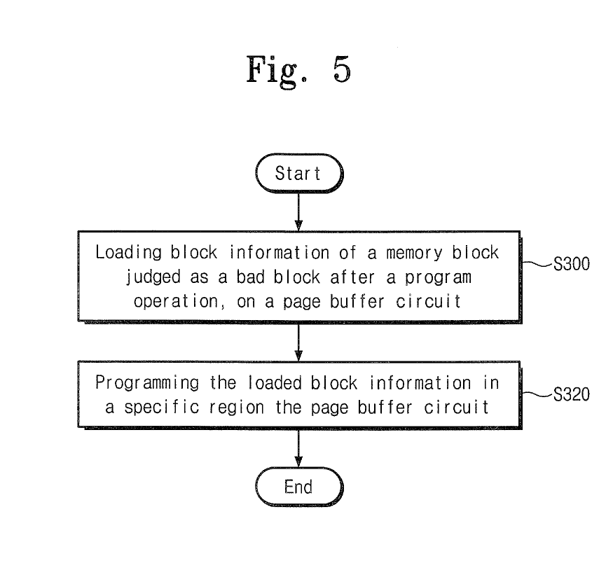

FIG. 5 is a flow chart showing an operation for storing bad block information when there are program fails in the flash memory device shown in FIG. 2.

As is well known, after completing a programming operation for a selected memory block, it is determined whether the programming operation has been successfully conducted. If a result of the determination informs of a program fail, the memory block with the program fail is treated as a bad block. For this, block information of the memory block detected as a bad block after programming is loaded into the page buffer circuit 300 (S300). Next, the loaded block information is programmed into the block information storing region 101 as a specific field through the page buffer circuit 300 (S320). The data stored in the memory block having a program fail may be copied into an empty memory block by means of a block substitution technique that is well known by those skilled in the art.

As stated above, it is possible to shorten a time for reading the block information by storing the block information of each memory block in the block information storing region not in the spare regions. Moreover, it is able to improve the efficiency of using the spare regions by storing the block information of each memory block in the block information storing region not in the spare regions.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed:

1. A semiconductor non-volatile memory device comprising:
a plurality of memory blocks each of which is segmented into main and spare regions; and
a block information storing region configured to store block information associated with the plurality of memory blocks.

2. The semiconductor memory device as set forth in claim 1, wherein the block information comprises bad block information for the plurality of memory blocks.

3. The semiconductor memory device as set forth in claim 1, wherein the block information storing region comprises one or more memory blocks.

4. The semiconductor memory device as set forth in claim 1, which further comprises:
a register block configured to temporarily store the block information read from the block information storing region at a power-up time.

5. The semiconductor memory device as set forth in claim 4, wherein the block information of the register block is output to an external system of the non-volatile memory device in response to a request from the external system.

6. The semiconductor memory device as set forth in claim 1 further comprising:
a read/write circuit receiving the block information associated with the plurality of memory blocks and configured to store the received block information in the block information storing region.

7. The semiconductor memory device as set forth in claim 6, wherein the read/write circuit comprises:
a control block;
a page buffer circuit configured to temporarily store the block information transferred through a column selection circuit under control of the control block; and
a row selection circuit selecting the block information storing region in accordance with regulation of the control block.

8. A flash memory device comprising:
a memory cell array including pluralities of memory blocks each of which is segmented into main and spare regions, and a block information storing region storing block information of the memory blocks;
a page buffer circuit configured to read the block information from the block information storing region; and
a register block configured to store the block information transferred from the page buffer circuit through a column selector circuit.

9. The flash memory device as set forth in claim 8, wherein the block information of the register block is output to an external system in response to a request from the external system.

10. The flash memory device as set forth in claim 8, wherein the block information comprises bad block information for the plurality of memory blocks.

11. The flash memory device as set forth in claim 8, wherein the block information storing region comprises one or more memory blocks.

12. The flash memory device as set forth in claim 8, wherein the block information of the memory blocks, which is to be stored in the block information storing region, is provided by an external system during a test operation.

13. The flash memory device as set forth in claim 8, wherein the page buffer circuit is configured to read the block information from the block information storing region at a power-up time.

14. The flash memory device as set forth in claim 8, which is a NAND flash memory device.

15. A method of operating a non-volatile memory device comprising
storing block information associated with a plurality of memory blocks of the non-volatile memory device in a separately addressable block information storing region.

16. A method according to claim 15 wherein the separately addressable block information storing region is outside a spare region associated with the plurality of memory blocks.

17. A method according to claim 15 wherein the separately addressable block information storing region comprises a single block of the non-volatile memory device including block information associated with the plurality of memory blocks.

18. A method according to claim 15 wherein the separately addressable block information storing region comprises a block of the non-volatile memory device including block information associated with at least two of the plurality of memory blocks.

19. A method according to claim 15 further comprising:
determining bad block information for the plurality of memory blocks during testing of the non-volatile memory device to provide the block information;
storing the block information in a page buffer circuit in the non-volatile memory device; and
transferring the block information from the page buffer circuit to the block information storing area.
